(19) United States
(12) Patent Application Publication
(10) Pub. No.: US 2015/0112881 A1
(43) Pub. Date: Apr. 23, 2015

(54) Automated Recruiting Application

(71) Applicant: Madhusudan Reddy Modugu, Raleigh, NC (US)

(72) Inventor: Madhusudan Reddy Modugu, Raleigh, NC (US)

(21) Appl. No.: 14/522,291

(22) Filed: Oct. 23, 2014

Related U.S. Application Data
(60) Provisional application No. 61/894,745, filed on Oct. 23, 2013.

(51) Int. Cl. G06Q 10/10

(52) U.S. Cl. CPC G06Q 10/1053
USPC 705/321

(57) ABSTRACT

An automated recruiting process, which utilizes behavior pattern analysis of a recruiter account, determines the best search criteria and finding potential employees for a job opening. By analyzing the search patterns of the recruiter account, the recruiting process creates a behavioral recruiting pattern description within a plurality of job-filling records so that the recruiting process can utilize the plurality of job-filling records for future job openings. When the recruiting process receives a new job posting, the recruiting process sequentially mimics the behavioral recruiting pattern description to identify preferred candidates for that respective new job posting. Once the preferred candidates are identified through the behavioral recruiting pattern description, the recruiting process forwards the preferred candidates to a hiring manager of the new job posting.

The current application claims a priority to the U.S. Provisional Patent application Ser. No. 61/894,745 filed on Oct. 23, 2014.

### FIELD OF THE INVENTION

The present invention relates generally to a recruiting system which is able to use behavioral data from human recruiters to find and identify the best candidates for job openings.

### BACKGROUND OF THE INVENTION

Recruiters, who attempt to find the best candidates for a job opening, face several hurdles. Not only must recruiters build up a solid and varied group of sources for potential candidates, they must also take the time to sort through the available resumes and find which make for the best candidates. This requires large time expenditure, as the recruiter must first determine what the job opening requires, and then search their sources matching resumes. Furthermore, since recruiters are only paid if their candidate is hired, they don't want to settle for adequate or even good candidates. A recruiter wants to present the best candidate available in order to maximize their chance of getting a commission.

To aid recruiters with their job, a number of system and resources have been developed. Most common is an aggregate source of resumes, along with a specifically designed search engine. These systems allow a recruiter to quickly search through a large number of resumes to find ones with the best matches. This is usually done by using key words that would show up in the resume of a qualifying candidate, which can even be automated by the system given an input of job title and requirements. While such systems are certainly a time saver when compared to manual searches, they have their faults. For one, by using simple keyword searches a recruiter might miss otherwise qualified candidates. Because the English language has a number of synonyms and even expressions which can be used to define the same concept or skill set, a keyword search can return a narrow and limited pool of candidates. By using an automated search system, a recruiter is unable to use their human talents to identify different or unusual resumes that would be well suited to a given job. Essentially, the recruiter is trading a decrease in time spent searching for a decrease in effective resume sorting. There exists a need for a recruiter system which can learn from and emulate human searches to identify the best potential candidates in an expedient manner.

It is therefore an object of the present invention to provide an automated recruiting application which analyzes previous searches performed by human recruiters to adjust queries to match the most successful queries performed for similar jobs filled by the recruiter in the past.

### BRIEF DESCRIPTION OF THE DRAWINGS

FIG. 1 is a flow chart illustrating the basic overall process of the present invention.

FIG. 2 is a flow chart illustrating the process of accumulating the plurality of job-filling records, wherein the accumulation of the plurality of job-filling records continues into FIG. 3.

FIG. 3 is a flow chart illustrating the process of accumulating the plurality of job-filling records, wherein the accumulation of the plurality of job-filling records is a continuation from FIG. 2.

FIG. 4 is a flow chart illustrating the desired communication means of the plurality of job-filling records.

FIG. 5 is a flow chart illustrating the analyzing process for each of the plurality of job-filling records in order to compute the successfulness rank.

FIG. 6 is a flow chart illustrating the comparison process of the job profile for each of the plurality of job-filling records with the new job profile in order to identify the set of similar records.

FIG. 7 is a flow chart illustrating the list of most-successful records of the present invention.

FIG. 8 is a flow chart illustrating the process of mimicking the behavioral recruiting pattern description of the present invention, wherein the process of mimicking the behavioral recruiting pattern description continues into FIG. 9.

FIG. 9 is a flow chart illustrating the process of mimicking the behavioral recruiting pattern description of the present invention, wherein the process of mimicking the behavioral recruiting pattern description is a continuation from FIG. 8.

FIG. 10 is a flow chart illustrating the process of mimicking the behavioral recruiting pattern description of the present invention, wherein the process of mimicking the behavioral recruiting pattern description is a continuation from FIG. 8 and FIG. 9.

FIG. 11 is a flow chart illustrating the process of mimicking the behavioral recruiting pattern description of the present invention, wherein the process of mimicking the behavioral recruiting pattern description is a continuation from FIG. 8, FIG. 9, and FIG. 10.

FIG. 12 is a flow chart illustrating the process forwarding the preferred candidates to the hiring manager.

### DETAIL DESCRIPTIONS OF THE INVENTION

All illustrations of the drawings are for the purpose of describing selected versions of the present invention and are not intended to limit the scope of the present invention.

The present invention is an automated recruiting process that utilizes behavior pattern analysis to determine the best search criteria for finding potential employees for a job opening. By analyzing the search patterns of recruiters, the present invention can use stored history of the present invention to determine the best search terms and potential requirements when looking to fill new job openings. The present invention continuously evolves as more and more potential employees are discovered through the overall process of the present invention. The present invention includes the steps of recording human performed searches, analyzing the results, and using the results to automate future searches. The first step requires a human recruiter, who generates search data for the present invention to analyze and emulate. The human recruiter goes about their job normally, searching databases and portals for resumes, identifying the right profile or profiles, and submitting the profiles to a job manager or hiring manager. Records relating to the progression of the submitted candidates, such as interviews, salary negotiations, information about the company, and information about other hired candidates, are recorded for the purpose of the present invention. Likewise, the search criteria used are stored for later analysis, as are the sources utilized for the searches. The process of the present invention is executed by computer-executable instructions stored on a non-transitory computer-readable medium so that recruiters, hiring managers, and a plurality of job applicants are able to interact with each other.

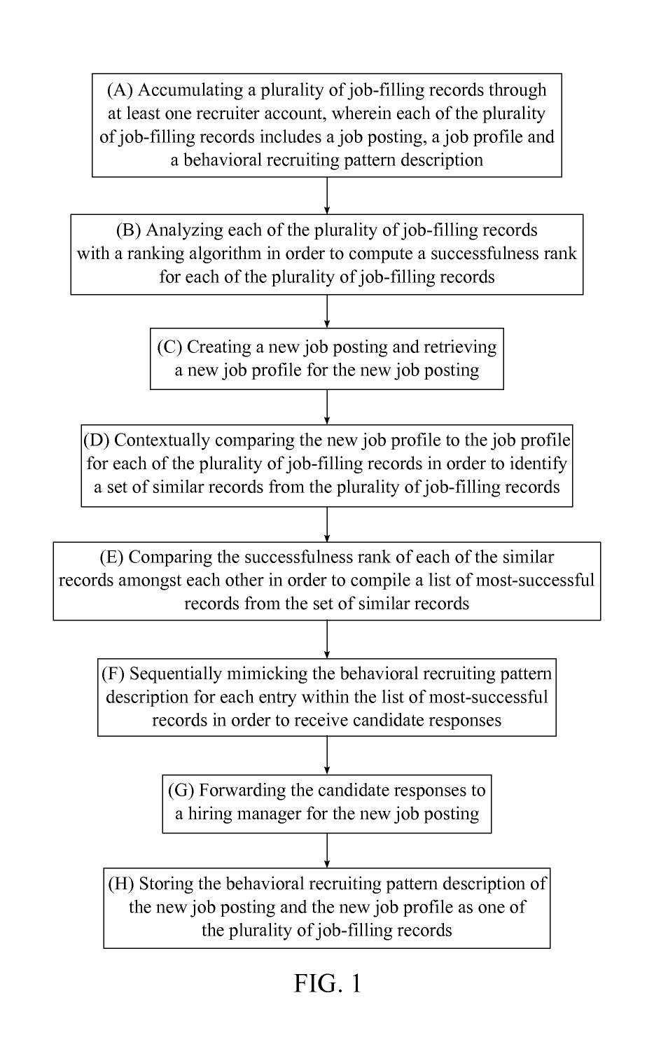

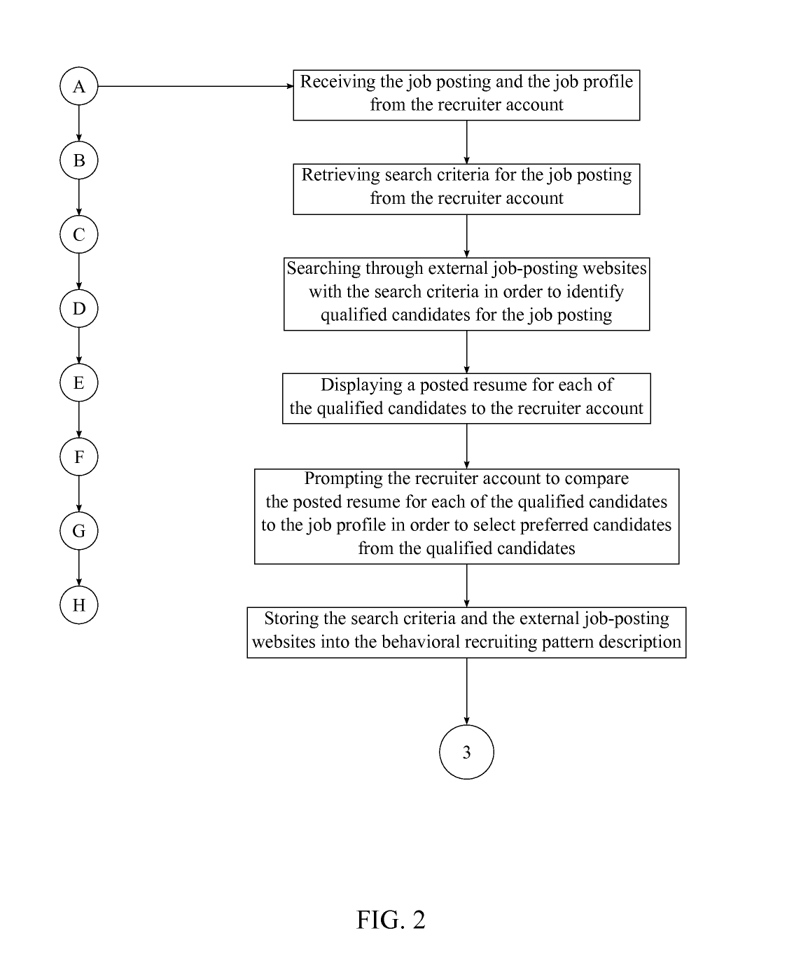

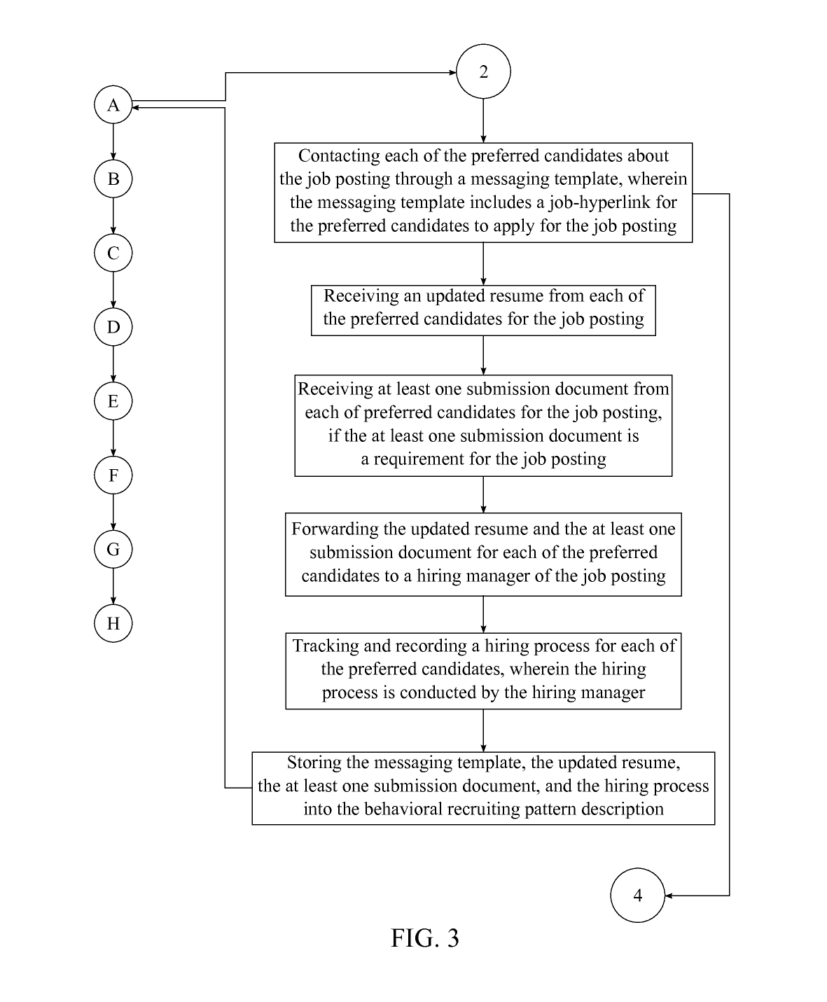

In order for the present invention efficiently function, a plurality of job-filling records has to be accumulated through at least one recruiter account as each of the plurality of job-filling records includes a job posting, a job profile, and a behavioral recruiting pattern description as seen on FIG. 1 and FIG. 2. More specifically, the recruiter account needs to create the job posting and the job profile for a particular job opening so that the present invention can receive the job posting and the job profile as the job profile preferably includes a job description, required qualifications, desired qualifications, and responsibilities. The particular job opening is generally provided from a client company and requires the recruiter account to find the plurality of job applicants for the particular job opening. In order to identify the plurality of job applicants, the recruiter account inputs search criteria that are related to the job posting. Then the present invention retrieves the search criteria for the job posting, and the present invention utilizes the search criteria to search through external job-posting websites in order to identify qualified candidates for the job posting. Once the qualified candidates are identified, the present invention displays a posted resume for each of the qualified candidates to the recruiter account. In reference to FIG. 1-FIG. 3, then the present invention prompts the recruiter account to compare the posted resume for each of the qualified candidates to the job profile so that preferred candidates for the job posting can be selected from the qualified candidates. For example, the recruiter account is able to narrow down a larger pool of the qualified candidates into a smaller pool of preferred candidates by utilizing the job profile. Once the preferred candidates are selected within the present invention, the search criteria and the external job-posting websites used to identify those preferred candidates are stored into the behavioral recruiting pattern description.

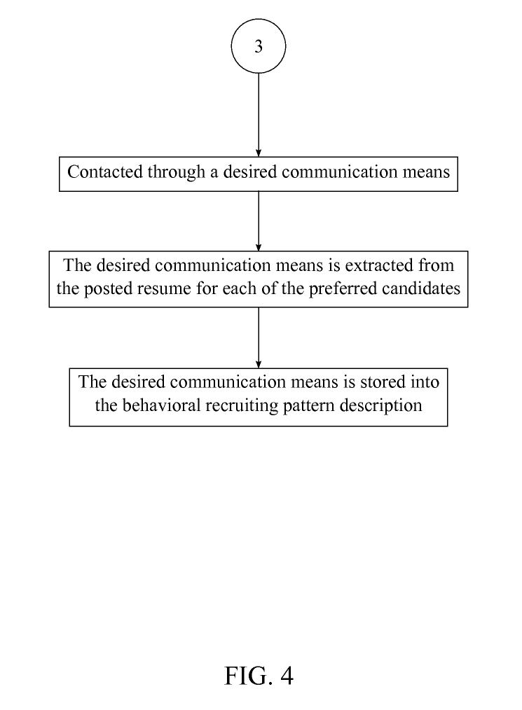

In reference to FIG. 1-FIG. 4, the present invention then contacts each of the preferred candidates about the job posting through a messaging template, wherein the messaging template includes a job-hyperlink for the preferred candidates to apply for the job posting. More specifically, each of the preferred candidates is contacted through a desired communication means as the desired communication means is extracted from the posted resume for each of the preferred candidates. The desired communication means of each of the preferred candidates is then stored into the behavioral recruiting pattern description. Then the preferred candidates have the option to apply for the job posting if they desired. The present invention then receives an updated resume from each of the preferred candidates for the job posting if each of the preferred candidates decides to apply for the job posting. The present invention also receives at least one submission document from each of the preferred candidates for the job posting if the at least one submission document is a requirement for the job posting. Then the present invention is able to forward the updated resume and the at least one submission document for each of the preferred candidates to a hiring manager of the job posting. The present invention also tracks and records a hiring process for each of the preferred candidates as the hiring process is conducted by the hiring manager of the job posting. At the same time, the present invention stores the messaging template, the updated resume, the at least one submission document, and the hiring process into the behavioral recruiting pattern description.

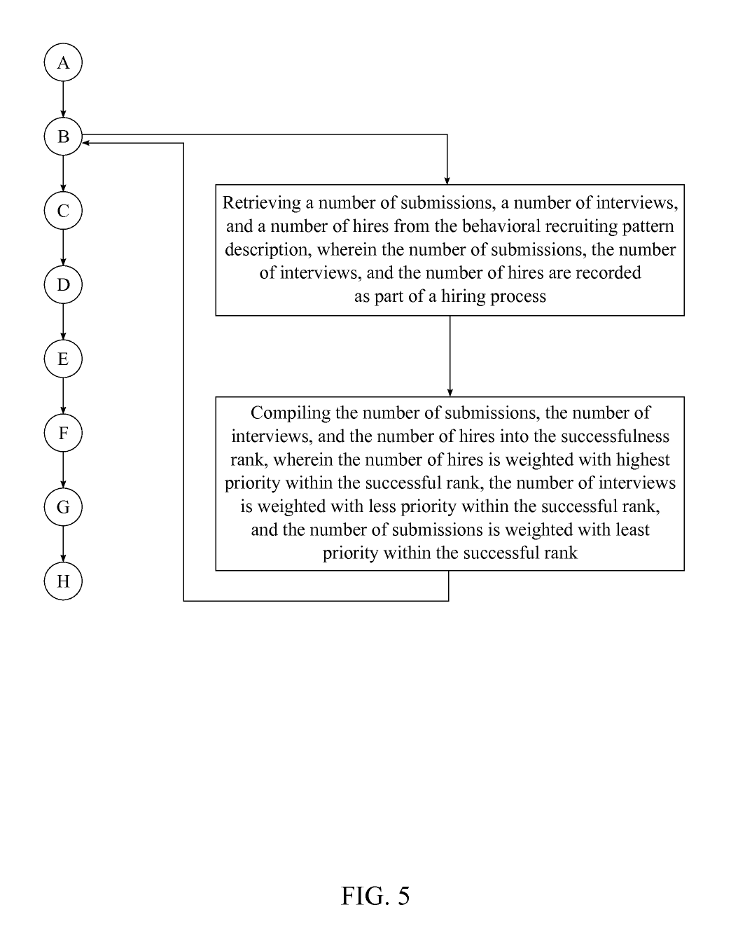

In reference to FIG. 1 and FIG. 5, the present invention then analyzes each of the plurality of job-filling records with a ranking algorithm in order to compute a successfulness rank for each of the plurality of job-filling records. Even though the ranking algorithm provides a successful rank for each of the plurality of job-filling records, the ranking algorithm mainly applied to the sub steps of the hiring process. More specifically, the ranking algorithm retrieves a number of submissions, a number of interviews, and a number of hires from each of the plurality of job-filling records as the number of submissions, the number of interviews, and the number of hires record as a part of the hiring process. Then the number of submissions, the number of interviews, and the number of hires are compiled together so that the successfulness rank for each of the plurality of job-filling records can be calculated through the ranking algorithm. The successfulness rank for each of the plurality of job-filling records is different from one another as the number of hires is weighted with highest priority within the successful rank, the number of interviews is weighted with less priority within the successful rank, and the number of submissions is weighted with least priority within the successful rank. Additionally, the successfulness rank for each of the plurality of job-filling records is stored within the behavioral recruiting pattern description. As a result, the present invention is able utilize the successfulness ranks as reference guide for future search inquiries to optimize the recruiting search process.

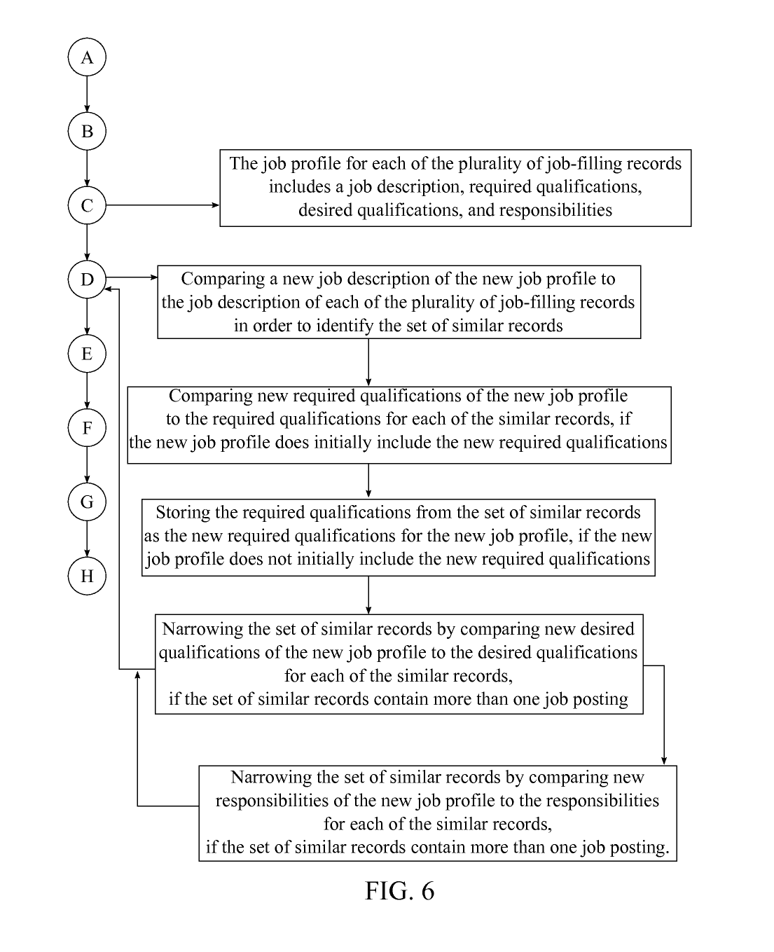

In reference to FIG. 1 and FIG. 6, when the recruiter account is presented with a new job profile that includes a new job description, new required qualifications, new desired qualifications, and new responsibilities, the recruiter account creates a new job posting within the present invention. The new job profile is also uploaded to the present invention so that the present invention is able to retrieve the new job profile for the new job posting. Once the present invention verifies the existence of the new job posting and the new job profile, the present invention contextually compares the new job profile to the job profile for each of the plurality of job-filling records in order to identify a set of similar records from the plurality of job-filling records. More specifically, the present invention first enables the recruiter account to filter the process of identifying the set of similar records as the recruiter account is able to narrow down the job category and the client company for the new job posting. For example, to match a lead programmer, the present invention would recognize (from the plurality of job-filling records) that searching the career site of a university with a strong programming department, such as Stanford, would be more ideal than searing the career site of a more medically oriented university such as Johns Hopkins. If the present invention is looking to fill an open position for a doctor, it would rank the Johns Hopkins career site as a much more relevant source. Whether the job category and the client company are selected or not, the present invention compares the new job description of the new job profile to the job description of each of the plurality of job-filling records in order to identify the set of similar records.

In reference to FIG. 6, then the present invention checks for the new required qualifications within the new job profile. If the new job profile initially includes the new required qualifications, the present invention compares the new required qualifications of the new job profile with the required qualifications for each of the similar records. If new job profile initially does not include the new required qualifications, the present invention stores the required qualifications for each of the similar records as the new required qualifications. Then the present invention is able to attain the set of similar records. In the event that the set of similar records includes more than one job postings, each posting within the set of similar records is narrowed according to the new desired qualifications and the new responsibilities. More specifically, when the set of similar records includes more than one job posting, the present invention narrows the set of similar records by comparing the new desired qualifications of the new job profile to the desired qualifications for each of the similar records.

In reference to FIG. 6, the set of similar records can be further narrowed down by the present invention if the set of similar records contain more than one job posting after the first comparison of the new job description against the job description for each of the similar records, the second comparison of the new required qualifications against the required qualifications for each of the similar records, and the third comparison of the new desired qualifications against the desired qualifications for each of the similar records. In order to further narrow down the set of similar records, the present invention compares the new responsibilities against the responsibilities for each of the similar records.

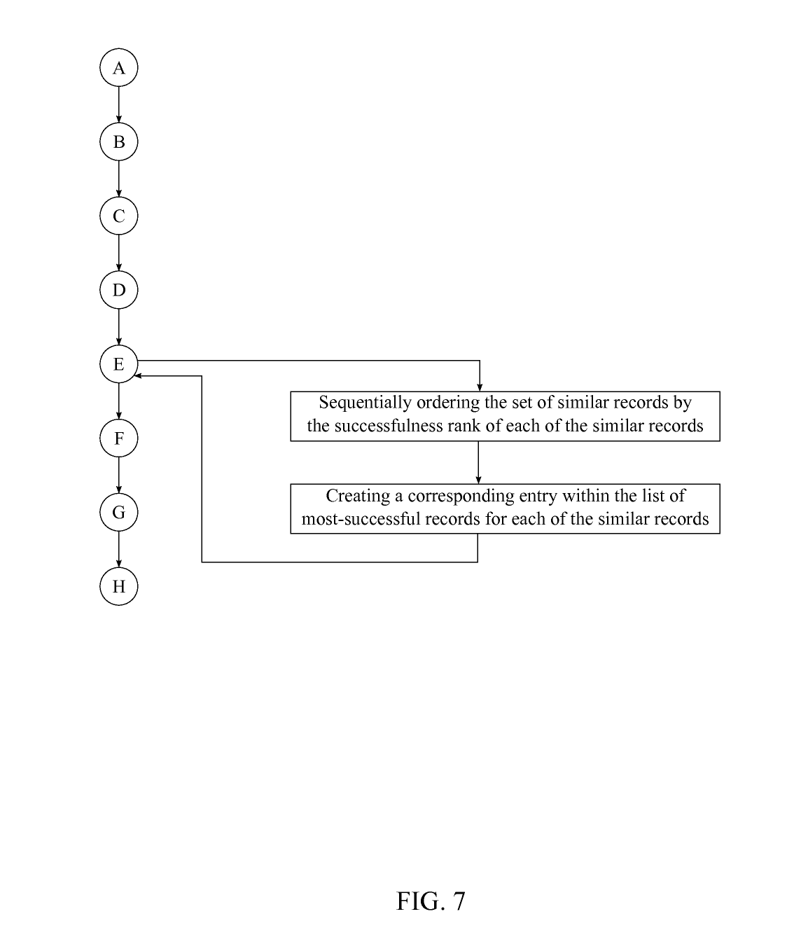

In reference to FIG. 1 and FIG. 7, the present invention then compares the successfulness rank of each of the similar records amongst each other so that a list of most-successful records can be created from the set of similar records. More specifically, the present invention sequentially orders the set of similar records by the successfulness rank of each of the similar records as a corresponding entry is created within the list of most-successful records for each of the similar records.

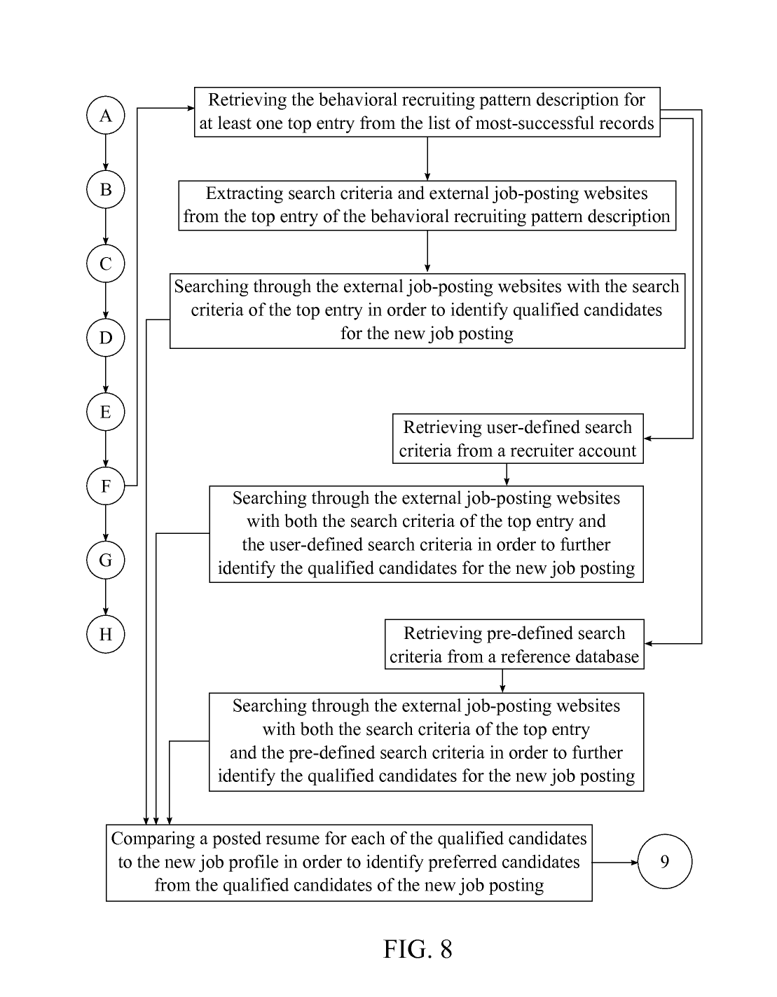

In reference to FIG. 1 and FIG. 8, the present invention then sequentially mimics the behavioral recruiting pattern description for each entry within the list of most-successful records in order to receive candidate responses for the new job posting. More specifically, the present invention retrieves the behavioral recruiting pattern description for at least one top entry from the list of most-successful records so that the search criteria and the external job-posting websites can be extracted from the top entry of the behavioral recruiting pattern description. Then the present invention utilizes the search criteria of the top entry through the external job-posting websites of the top entry in order to identify qualified candidates for the new job posting. Since the top entry of the list of most-successful records represents the height valve for the successfulness rank, the qualified candidates selected from the search criteria and the external job-posting websites of the top entry are considered as high priority qualified candidates for the new job posting.

In reference to FIG. 1 and FIG. 8, the recruiter account can also upload user-defined search criteria to the present invention so that the identifying of the preferred candidates for the new job posting can be further clarified. In the event that the present invention retrieve the user-defined search criteria from the recruiter account, the present invention searches the external job-posting websites of the top entry with both the search criteria of the top entry and the user-defined search criteria so that the qualified candidates for the new job posting can be identified. The qualified candidates selected from the search criteria of the top entry and the user-defined search criteria are considered as less priority qualified candidates for the new job posting.

In reference to FIG. 1 and FIG. 8, when the present invention is unable to find search criteria from the top entry and the user-defined search criteria is not received by the recruiter account, the present invention retrieves pre-defined search criteria for the top entry from a reference database. The present invention then searches the external job-posting websites of the top entry with the pre-defined search criteria so that the qualified candidates for the new job posting can be identified. The qualified candidates selected from the pre-defined search criteria are considered as least priority qualified candidates for the new job posting.

For example, if the present invention is presented with the aforementioned programmer position, the present invention would look through the plurality of job-filling records for similar job postings that the recruiter account attempted to fill. In addition to finding the search criteria and the external job-posting websites that are used to find the best candidates (ideally the preferred candidate that got hired for a job posting), the present invention can determine the best search criteria and external job-posting websites to use for the new job posting. In addition, the present invention can also identify poor search criteria that should be excluded, or at least elaborated upon, during the search. For example, the term “lead” is could be used in several other job descriptions. In addition, the term “lead” might exclude otherwise qualified candidates. A resume which includes the job title “head programmer” could very well be suited for the job opening, but by using a narrow term like “lead” the resume would be missed. The present invention recognizes this and omits the term lead, or chooses a more general term that is less likely to omit potentially qualified candidates.

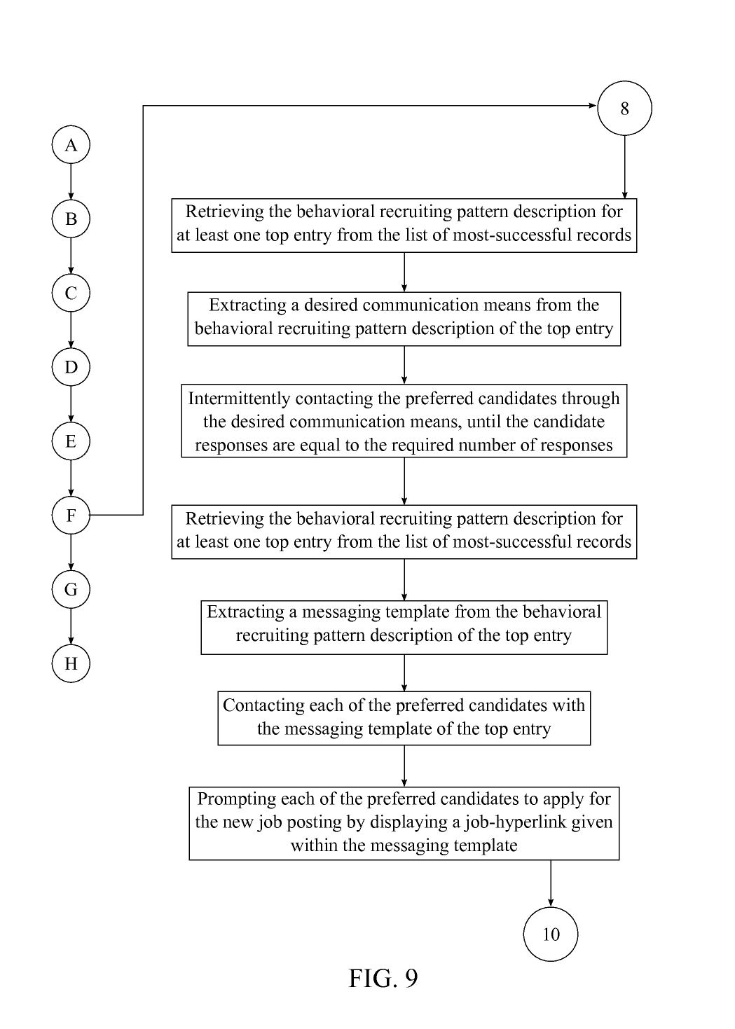

In reference to FIG. 1 and FIG. 9, once the qualified candidates are identified, the present invention compares a posted resume for each of the qualified candidates to the new job profile so that the qualified candidates of the new job posting can be narrowed down into preferred candidates of the new job posting. The present invention then retrieves the behavioral recruiting pattern description for the top entry so that the desired communication means and the messaging template from the behavioral recruiting pattern description can be extracted.

In reference to FIG. 1 and FIG. 9, then each of the preferred candidates is intermittently contacted by the present invention through the desired communication means so that the messaging template can be sent to each of the preferred candidates, unit the candidate responses of the new job posting are equal to a required number of responses. The required number of responses of the new job posting is provided by the client company and generally indicates the minimum number of responses that the client company requested for the new job posting. The messaging template gauges the interest of each of the preferred candidates and prompts each of the preferred candidates to apply for the new job posting by displaying a job-hyperlink given within the messaging template. The job-hyperlink redirects each of the preferred candidates to the present invention so that the preferred candidates who decide to apply for the new job posting are able to interact with the present invention.

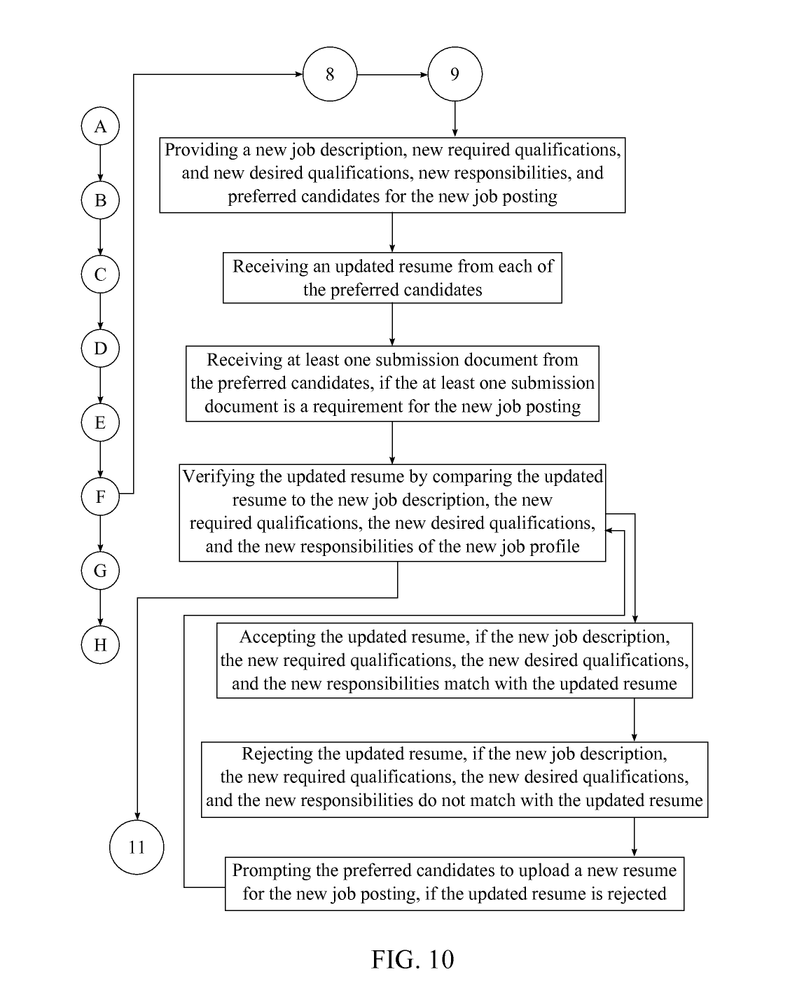

In reference to FIG. 10, once the preferred candidates apply for the new job posting, the present invention receives an updated resume from each of the preferred candidates for the new job posting. Additionally, the present invention also receives at least one submission document form each of the preferred candidates of the new job posting if the at least one submission document is a requirement for the new job posting. For example, if the new job posting requires a cover letter or a writing sample, the preferred candidate is asked to upload the necessary documents as the at least one submission document. Then the present invention verified the updated resume by comparing the updated resume to the new job description, the new required qualifications, the new desired qualifications, and the new responsibilities of the new job posting. More specifically, if the new job description, the new required qualifications, the new desired qualifications, and the new responsibilities match with the updated resume, the present invention accepts the updated resume. However, if the new job description, the new required qualifications, the new desired qualifications, and the new responsibilities do not match with the updated resume, the present invention rejects the updated resume. After rejecting the updated resume, the present invention prompts the respective preferred candidates to upload a new resume for the new job posting.

Ideally, the present invention finds the preferred candidates who match the new job description, the new required qualifications, the new desired qualifications, and the new responsibilities. The present invention then rate those preferred candidates as 100% matching candidates for the new job posting. However, if some the preferred candidates does not match the new job description, the new required qualifications, the new desired qualifications, and the new responsibilities, they are given a correspondingly lower match percentage. The present invention is designed to prioritize the preferred candidates by first looking for the preferred candidates who completely match the four requirements, which are the new job description, the new required qualifications, the new desired qualifications, and the new responsibilities. The present invention then broadens the search criteria as necessary to find more preferred candidates. This allows the present invention to identify a larger number of preferred candidates while still finding the strongest possible preferred candidates. Even with the broadest search criteria, the present invention only selects the preferred candidates that have the four requirements present; as it is assumed any preferred candidates without the four requirements can be get rejected by the hiring company. In addition to reviewing the four requirements of the preferred candidates, the present invention also ensures that the preferred candidates meet any minimum experience requirements. For example, if a job posting requires at least 5 years of work experience as a programmer, the present invention reviews the work history of the preferred candidates and filters out those with less than 5 years experience. In the same manner, the present invention determines what previous queries are relevant to the job posting so that the work history of a resume can be reviewed to determine which entries count towards the minimum required experience.

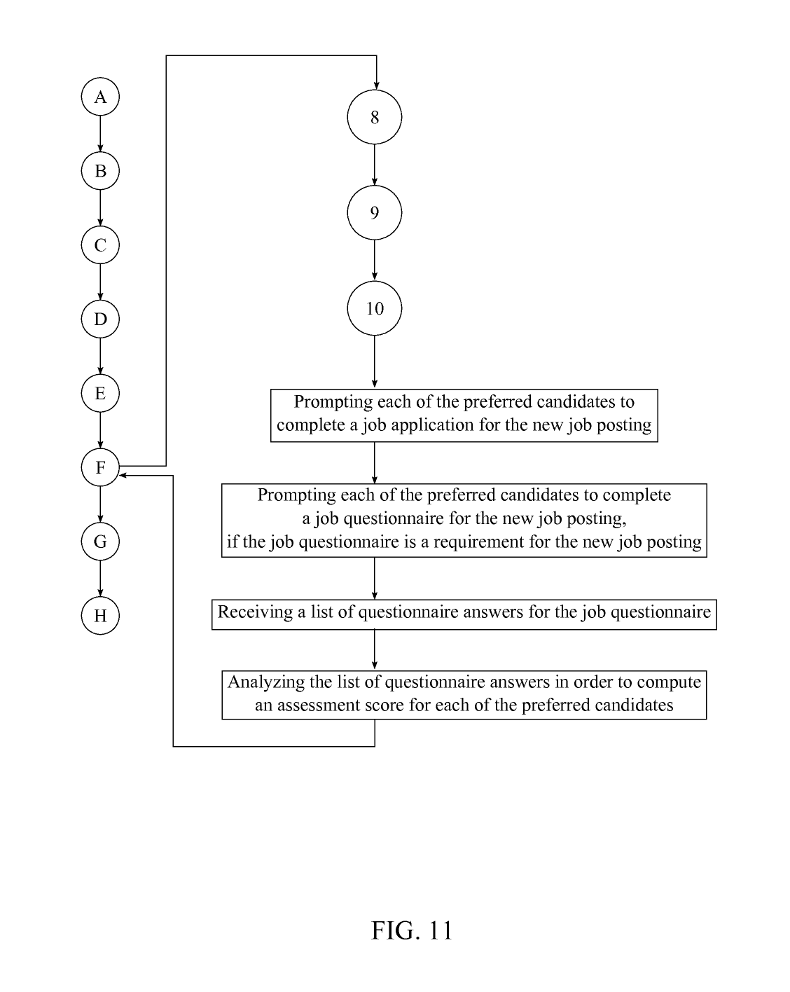

In reference to FIG. 11, once the updated resume or the new resume is retrieved by the present invention, the present invention prompts each of the preferred candidates to complete a job application for the new job posting. Additionally, the preferred candidates are also provided with an option to update or address any remaining documents required for the job application. The present invention also prompts each of the preferred candidates to complete a job questionnaire if the job questionnaire is a requirement for the new job posting. When the job questionnaire is a requirement for the new job posting, the present invention can draw information from the updated resume or the new resume of a job posting and from other personal information to answer relevant fields in the job questionnaire, leaving the preferred candidates to fill in any remaining blank fields. Additionally, the present invention has the ability to retrieve and attach the job questionnaire from a questionnaire template bank so that the preferred candidates can take a technical and/or behavioral assessment test while completing the job application.

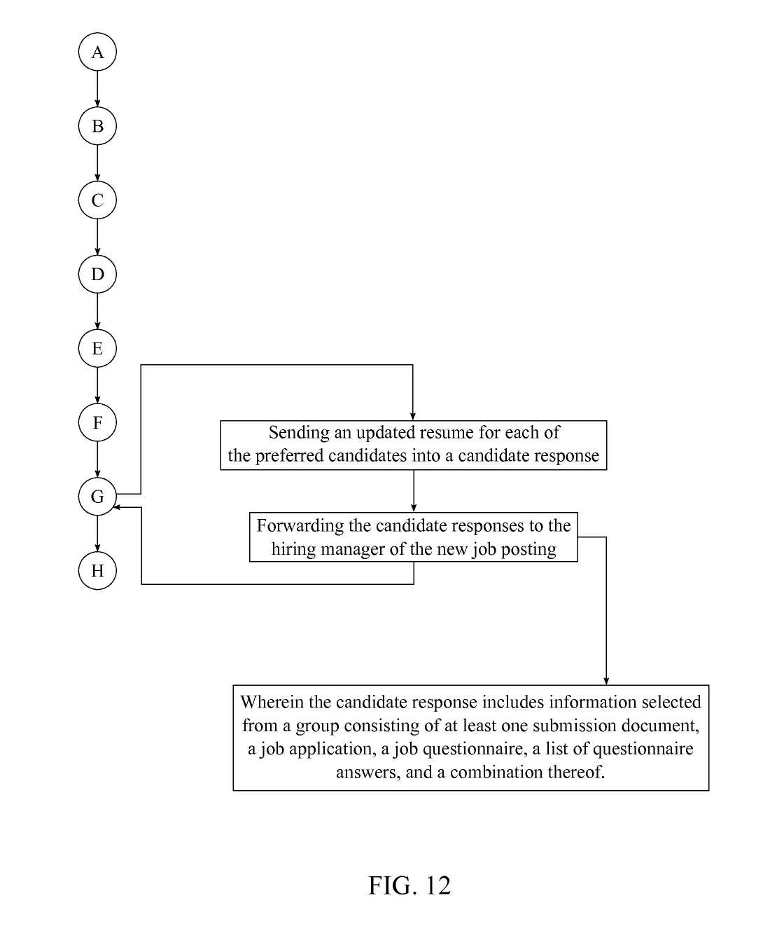

In reference to FIG. 12, the present invention then receives a list of questionnaire answers for the job questionnaire and analyzes the list of questionnaire answers in order to compute an assessment score for each of the preferred candidates. Once the required number of responses is met within the present invention, the present invention closes the new job posting and forwards the candidate responses to the hiring manager of the new job posting, wherein the sending of the updated resume or the new resume is considered as a candidate response. Depending the new job posting, the candidate responses can also include the at least one submission document, the job application, the job questionnaire, the list of questionnaire answers, and a combination thereof in addition to the updated resume or the new resume.

Then the present invention stores the behavioral recruiting pattern description of the new job posting and the new job profile as one of the plurality of job-filling records. Overall, the automated recruiting process provided by the present invention allows the recruiter accounts to more effectively and quickly find potential candidates to fill a job opening greatly reducing the amount of time that the recruiter account spends searching for and identifying the ideal candidate. This allows recruiters to shift their focus from sourcing, which currently takes up the majority of their time, to negotiating and selling, ultimately increasing profit. The present invention also functions as a knowledge retention platform as the behavioral pattern description retains the work conducted by the recruiter accounts. As a result, the present invention able to retain valuable information about the behavioral pattern description for future searches and become an independent search module apart from the recruiter accounts.

Although the invention has been explained in relation to its preferred embodiment, it is to be understood that many other possible modifications and variations can be made without departing from the spirit and scope of the invention as hereinafter claimed.

What is claimed is:

1. An automated recruiting application for identifying best candidates by executing computer-executable instructions stored on a non-transitory computer-readable medium, the method comprises the steps of:
accumulating a plurality of job-filling records through at least one recruiter account, wherein each of the plurality of job-filling records includes a job posting, a job profile and a behavioral recruiting pattern description;
analyzing each of the plurality of job-filling records with a ranking algorithm in order to compute a successfulness rank for each of the plurality of job-filling records;
creating a new job posting and retrieving a new job profile for the new job posting;
contextually comparing the new job profile to the job profile for each of the plurality of job-filling records in order to identify a set of similar records from the plurality of job-filling records;
comparing the successfulness rank of each of the similar records amongst each other in order to compile a list of most-successful records from the set of similar records;
sequentially mimicking the behavioral recruiting pattern description for each entry within the list of most-successful records in order to receive candidate responses;
forwarding the candidate responses to a hiring manager for the new job posting; and
storing the behavioral recruiting pattern description of the new job posting and the new job profile as one of the plurality of job-filling records.

2. The automated recruiting application for identifying best candidates by executing computer-executable instructions stored on a non-transitory computer-readable medium, the method as claimed in claim 1 comprises the steps of:
receiving the job posting and the job profile from the recruiter account;
retrieving search criteria for the job posting from the recruiter account;
searching through external job-posting websites with the search criteria in order to identify qualified candidates for the job posting;
displaying a posted resume for each of the qualified candidates to the recruiter account;
prompting the recruiter account to compare the posted resume for each of the qualified candidates to the job profile in order to select preferred candidates from the qualified candidates; and
storing the search criteria and the external job-posting websites into the behavioral recruiting pattern description.

3. The automated recruiting application for identifying best candidates by executing computer-executable instructions stored on a non-transitory computer-readable medium, the method as claimed in claim 1 comprises the steps of:
providing preferred candidates for the job posting;
providing a posted resume for each of the preferred candidates;
contacting each of the preferred candidates about the job posting through a messaging template, wherein the messaging template includes a job-hyperlink for the preferred candidates to apply for the job posting;
receiving an updated resume from each of the preferred candidates for the job posting;
receiving at least one submission document from each of preferred candidates for the job posting,
if the at least one submission document is a requirement for the job posting;
forwarding the updated resume and the at least one submission document for each of the preferred candidates to a hiring manager of the job posting;
tracking and recording a hiring process for each of the preferred candidates, wherein the hiring process is conducted by the hiring manager; and
storing the messaging template, the updated resume, the at least one submission document, and the hiring process into the behavioral recruiting pattern description.

4. The automated recruiting application for identifying best candidates by executing computer-executable instructions stored on a non-transitory computer-readable medium, as claimed in claim 3, wherein:
each of the preferred candidates is contacted through a desired communication means;
the desired communication means is extracted from the posted resume for each of the preferred candidates;
the desired communication means is stored into the behavioral recruiting pattern description.

5. The automated recruiting application for identifying best candidates by executing computer-executable instructions stored on a non-transitory computer-readable medium, the method as claimed in claim 1 comprises the steps of:
retrieving a number of submissions, a number of interviews, and a number of hires from the behavioral recruiting pattern description, wherein the number of submissions, the number of interviews, and the number of hires are recorded as part of a hiring process; and
compiling the number of submissions, the number of interviews, and the number of hires into the successfulness rank, wherein the number of hires is weighted with highest priority within the successful rank, the number of interviews is weighted with less priority within the successful rank, and the number of submissions is weighted with least priority within the successful rank.

6. The automated recruiting application for identifying best candidates by executing computer-executable instructions stored on a non-transitory computer-readable medium, the method as claimed in claim 1 comprises the steps of:
wherein the job profile for each of the plurality of job-filling records includes a job description, required qualifications, desired qualifications, and responsibilities;
comparing a new job description of the new job profile to the job description of each of the plurality of job-filling records in order to identify the set of similar records;
comparing new required qualifications of the new job profile to the required qualifications for each of the similar records,
if the new job profile does initially include the new required qualifications;
storing the required qualifications from the set of similar records as the new required qualifications for the new job profile,
if the new job profile does not initially include the new required qualifications; and
narrowing the set of similar records by comparing new desired qualifications of the new job profile to the desired qualifications for each of the similar records,
if the set of similar records contain more than one job posting.

7. The automated recruiting application for identifying best candidates by executing computer-executable instructions stored on a non-transitory computer-readable medium, the method as claimed in claim 6 comprises the steps of:
narrowing the set of similar records by comparing new responsibilities of the new job profile to the responsibilities for each of the similar records,
if the set of similar records contain more than one job posting.

8. The automated recruiting application for identifying best candidates by executing computer-executable instructions stored on a non-transitory computer-readable medium, the method as claimed in claim 1 comprises the steps of:
sequentially ordering the set of similar records by the successfulness rank of each of the similar records; and
creating a corresponding entry within the list of most-successful records for each of the similar records.

9. The automated recruiting application for identifying best candidates by executing computer-executable instructions stored on a non-transitory computer-readable medium, the method as claimed in claim 1 comprises the steps of:
retrieving the behavioral recruiting pattern description for at least one top entry from the list of most-successful records;
extracting search criteria and external job-posting websites from the top entry of the behavioral recruiting pattern description;
searching through the external job-posting websites with the search criteria of the top entry in order to identify qualified candidates for the new job posting; and
comparing a posted resume for each of the qualified candidates to the new job profile in order to identify preferred candidates from the qualified candidates of the new job posting.

10. The automated recruiting application for identifying best candidates by executing computer-executable instructions stored on a non-transitory computer-readable medium, the method as claimed in claim 9 comprises the steps of:
retrieving user-defined search criteria from a recruiter account; and
searching through the external job-posting websites with both the search criteria of the top entry and the user-defined search criteria in order to further identify the qualified candidates for the new job posting.

11. The automated recruiting application for identifying best candidates by executing computer-executable instructions stored on a non-transitory computer-readable medium, the method as claimed in claim 9 comprises the steps of:
retrieving pre-defined search criteria from a reference database; and
searching through the external job-posting websites with both the search criteria of the top entry and the pre-defined search criteria in order to further identify the qualified candidates for the new job posting.

12. The automated recruiting application for identifying best candidates by executing computer-executable instructions stored on a non-transitory computer-readable medium, as claimed in claim 1, wherein:
providing preferred candidates for the new job posting, wherein the new job posting includes a required number of responses;
retrieving the behavioral recruiting pattern description for at least one top entry from the list of most-successful records;
extracting a desired communication means from the behavioral recruiting pattern description of the top entry; and
intermittently contacting the preferred candidates through the desired communication means, until the candidate responses are equal to the required number of responses.

13. The automated recruiting application for identifying best candidates by executing computer-executable instructions stored on a non-transitory computer-readable medium, as claimed in claim 1, wherein:
providing preferred candidates for the new job posting;
retrieving the behavioral recruiting pattern description for at least one top entry from the list of most-successful records;
extracting a messaging template from the behavioral recruiting pattern description of the top entry;
contacting each of the preferred candidates with the messaging template of the top entry; and
prompting each of the preferred candidates to apply for the new job posting by displaying a job-hyperlink given within the messaging template.

14. The automated recruiting application for identifying best candidates by executing computer-executable instructions stored on a non-transitory computer-readable medium, the method as claimed in claim 1 comprises the steps of:
providing a new job description, new required qualifications, and new desired qualifications, new responsibilities, and preferred candidates for the new job posting;
receiving an updated resume from each of the preferred candidates;
receiving at least one submission document from the preferred candidates,
if the at least one submission document is a requirement for the new job posting; and
verifying the updated resume by comparing the updated resume to the new job description, the new required qualifications, the new desired qualifications, and the new responsibilities of the new job profile.

15. The automated recruiting application for identifying best candidates by executing computer-executable instructions stored on a non-transitory computer-readable medium, the method as claimed in claim 14 comprises the steps of:
accepting the updated resume,
if the new job description, the new required qualifications, the new desired qualifications, and the new responsibilities match with the updated resume;
rejecting the updated resume,
if the new job description, the new required qualifications, the new desired qualifications, and the new responsibilities do not match with the updated resume; and
prompting the preferred candidates to upload a new resume for the new job posting,
if the updated resume is rejected.

16. The automated recruiting application for identifying best candidates by executing computer-executable instructions stored on a non-transitory computer-readable medium, the method as claimed in claim 1 comprises the steps of:
providing preferred candidates for the new job posting;
prompting each of the preferred candidates to complete a job application for the new job posting;
prompting each of the preferred candidates to complete a job questionnaire for the new job posting,
if the job questionnaire is a requirement for the new job posting;
receiving a list of questionnaire answers for the job questionnaire; and
analyzing the list of questionnaire answers in order to compute an assessment score for each of the preferred candidates.

17. The automated recruiting application for identifying best candidates by executing computer-executable instructions stored on a non-transitory computer-readable medium, the method as claimed in claim 1 comprises the steps of:
providing preferred candidates for the new job posting;
sending an updated resume for each of the preferred candidates into a candidate response; and
forwarding the candidate responses to the hiring manager of the new job posting.

18. The automated recruiting application for identifying best candidates by executing computer-executable instructions stored on a non-transitory computer-readable medium, the method as claimed in claim 1, wherein the candidate response includes information selected from a group consisting of at least one submission document, a job application, a job questionnaire, a list of questionnaire answers, and a combination thereof.
